(19) United States
(12) Patent Application Publication
(10) Pub. No.: US 2013/0202194 A1
(43) Pub. Date: Aug. 8, 2013

(54) Method for generating high resolution depth images from low resolution depth images using edge information

(71) Applicants: Danillo Bracco Graziosi, Somerville, MA (US); Dong Tian, Boxborough, MA (US); Anthony Vetro, Arlington, VA (US)

(72) Inventors: Danillo Bracco Graziosi, Somerville, MA (US); Dong Tian, Boxborough, MA (US); Anthony Vetro, Arlington, VA (US)

(21) Appl. No.: 13/366,321

(22) Filed: Feb. 5, 2012

(51) Int. Cl. G06K 9/00

(52) U.S. Cl. 382/154

(57) ABSTRACT

A method interpolates and filters a depth image with reduced resolution to recover a high resolution depth image using edge information, wherein each depth image includes an array of pixels at locations and wherein each pixel has a depth. The reduced depth image is first up-sampled, interpolating the missing positions by repeating the nearest-neighboring depth value. Next, a moving window is applied to the pixels in the up-sampled depth image. The window covers a set of pixels centred at each pixel. The pixels covered by the window are selected according to their relative position to the edge, and only pixels that are within the same side of the edge of the centre pixel are used for the filtering procedure. A single representative depth from the set of selected pixel in the window is assigned to the pixel to produce a processed depth image.

### FIELD OF THE INVENTION

This invention relates generally to image processing and compression, and more particularly to up-sampling and reconstruction filters applied to depth images.

### BACKGROUND OF THE INVENTION

Depth Images

Depth images represent distances from a camera to a 3D scene. Efficient encoding of depth images is important for 3D video, and free view television (FTV). FTV enables a user to interactively control the view and generate new virtual images of a dynamic scene from arbitrary view point.

Most conventional image-based rendering (IBR) methods use the depth images, in combination with stereo or multi-image videos, to enable 3D and FTV. The multi-image video coding (MVC) extension of the H.264/AVC standard supports inter-view image prediction for improved coding efficiency for the multi-view images and videos. However, MVC does not specify any particular encoding for the depth images.

There is prior art that describes formats comprised of multi-view images and videos with corresponding depth images. The compression of these formats could be achieved with future extensions to AVC and HEVC (High Efficient Video Coding), an emerging standard for the next generation of video compression. In such a framework, the texture and depth can be compressed jointly. A scene is acquired with multiple cameras, and for each view, the corresponding depth image is obtained. With the use of multiple views, the depths, and the scene geometry, a higher quality can be obtained for a synthesized virtual view, generated with depth-image based rendering (DIBR) procedures.

There is a substantial redundancy between the texture images and the corresponding depth images, because both the texture and depth images depict the same objects in the 3D scene. Nevertheless, depth images usually have less entropy than texture images. Texture and depth image redundancies can be also determined between views.

Unlike conventional images, depth images are spatially monotonous except at depth discontinuities. Thus, decoding errors tend to be concentrated near depth discontinuities, and failure to preserve the depth discontinuities significantly compromises the quality of virtual images.

Encoding a reduced resolution depth image can reduce the bit rate substantially, but the loss of resolution also degrades the quality of the depth images, especially in high frequency regions, such as at depth discontinuities. Artifacts in the virtual images are visually annoying. Conventional down/up samplers either use a low-pass filter or an interpolation filter to minimize the quality degradation. That is, the conventional filters combine the depths of several pixels covered by the filter in some way for each filtered pixel. That filtering “smears” or blurs depth discontinuities because the filtering depends on multiple depths.

Prior art approaches have been developed to overcome the limitations of conventional down/up-sampling techniques with approaches that explicitly attempt to maintain edge quality, see for example U.S. patent application Ser. No. 12/405,884, “Method for Up-Sampling Depth Images,” filed by Yea, et al., on Mar. 17, 2009. Such methods only rely on the down-sampled depth image data itself to recover the high resolution depth image.

Depth images can be obtained by range cameras. The images obtained from range cameras can have a lower resolution than the corresponding texture images, and an up-sampling procedure is necessary for the synthesis of virtual views from the scene geometry.

Because the depth video and image rendering results are sensitive to variations in space and time, especially at depth discontinuities, the conventional depth reconstruction methods are insufficient, especially for virtual image synthesis.

### SUMMARY OF THE INVENTION

The embodiments of the invention provide a method for interpolating and filtering a low resolution depth image to construct a high resolution depth image using information associated with depth discontinuities, e.g., edges. Each depth image includes an array of pixels at locations (x, y), and each pixel has an associated depth.

First, the low resolution depth image is up-sampled. Missing depths arc interpolated by duplicating nearest-neighboring depths.

Next, a moving window is applied to the pixels in the up-sampled depth image. A size of the window covers a set of pixels centred at each pixel.

The pixels covered by each window are selected according to their relative position to a depth discontinuity, and only pixels that are on the same side of the discontinuity of the center pixel are used for the filtering. The discontinuity information can be from the correspondent texture image, explicitly sent from an encoder, implicitly obtained through analysis of the low resolution depth image, or from a high resolution side view depth image, after warping.

A single representative depth from the set of selected pixel in the window is assigned to the pixel to generate the high resolution depth image.

### BRIEF DESCRIPTION OF THE DRAWINGS

FIG. 1 is a block diagram of a video coding system including view synthesis using embodiments of the invention;

FIG. 2 is a block diagram of a video coding system for depth images with edges extracted from texture image, using embodiments of the invention;

FIG. 3 is a block diagram of a video coding system for depth images with edges explicitly sent to a decoder, using embodiments of the invention;

FIG. 4A is a block diagram of an AVC codec for decoding a texture image according to embodiments of the invention;

FIG. 4B is a block diagram of an AVC codec for decoding a depth image according to embodiments of the invention;

FIG. 5 is a block diagram of an AVC codec with in-loop up-sampling and depth reconstruction using embodiments of the invention;

FIG. 6 is a block diagram of an up-sampling and reconstruction depth filter for one embodiment of the invention;

FIG. 8 is a flow diagram of a method for selecting blocks for depth filtering according to embodiments of the invention; and

FIGS. 9A-9D are block diagrams of details of the region-based median filter according to embodiments of the invention.

### DETAILED DESCRIPTION OF THE PREFERRED EMBODIMENTS

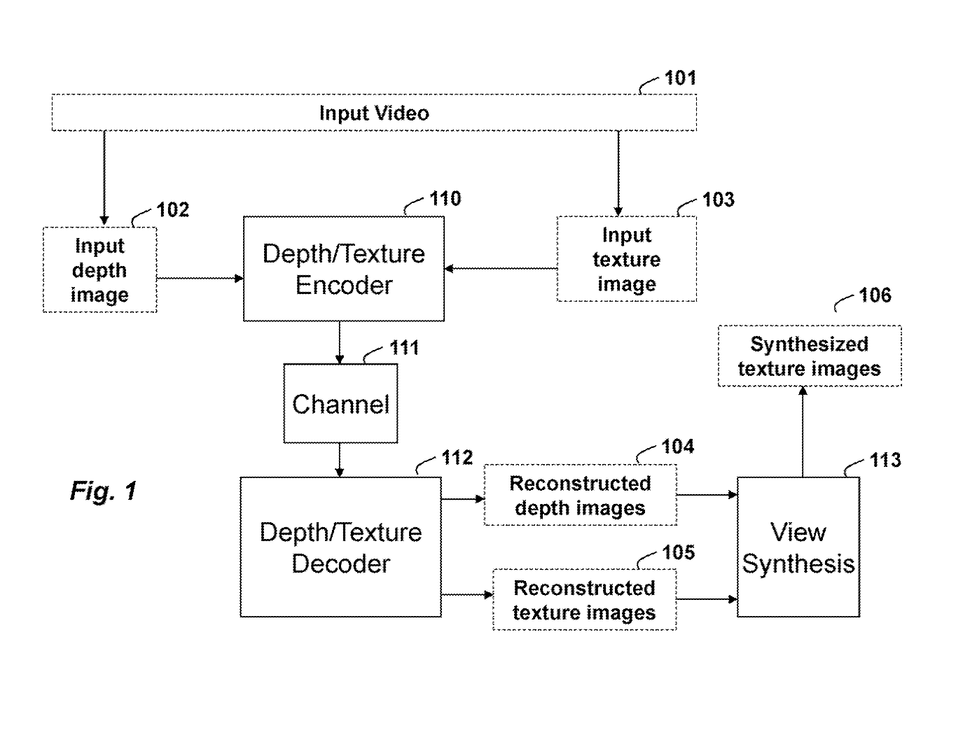

As shown in FIG. 1, a video coding system according embodiments of our invention, takes as input a video 101 that includes a sequence of texture images 103 and a corresponding sequence of depth images 102.

The embodiments of the invention concentrate on filtering of the depth images and generating high resolution depth images from the low resolution depth images and depth discontinuity information, e.g., edges, extracted from the texture images.

Alternatively, the edge information can be obtained from other sources, e.g., by using warped depth images from other views, such as a high resolution side view depth image, after warping, or by explicitly sending the edge information from an encoder. The high resolution depth images can be used for virtual image synthesis for either display purpose or view synthesis prediction.

In FIG. 1, the input video 101 includes the texture images 103 and the depth images 102 that are encoded by a texture and depth encoder 110 and passed through a channel 111 to a texture and depth decoder 112.

The decoder outputs reconstructed texture images 105 and reconstructed depth images 104, which are used as input to a view synthesis module 113 to produce a synthesized virtual texture image 106.

Four embodiments are described below.

### Embodiment 1

For some embodiments, the depth images can have a resolution lower than the resolution of the texture image. One embodiment down-samples the input depth image before encoding to improve encoding efficiency.

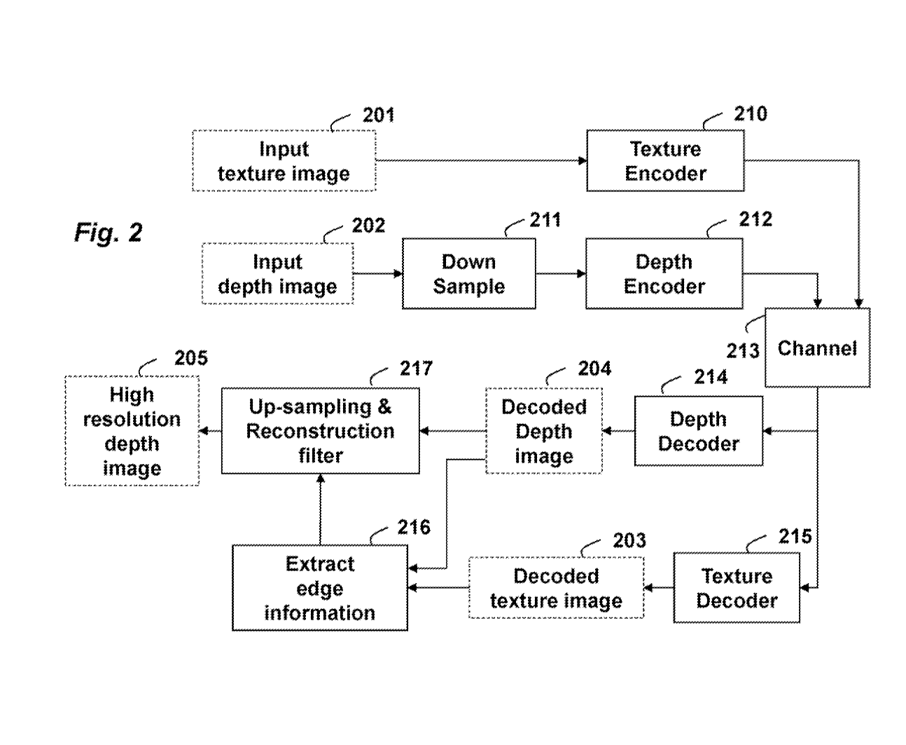

FIG. 2 shows a first embodiment of the invention to use the edge information to assist the depth up-sampling and reconstruction.

The input includes one or more texture images 201, and corresponding depth images 202. The texture images 201 are encoded 210, passed through a channel 213 and decoded 215.

Before the depth encoding 212, the high resolution depth image 202 is down-sampled 211 to reduce the resolution of the depth image. The input depth image can already be a low resolution depth image. Nevertheless, the depth image still needs to be up-sampled for view synthesis.

The low resolution depth image is coded 212 and passes through the channel 213 to a depth decoder 214. Because the decoded depth image 204 has a lower resolution, an up-sampling and reconstruction filter 217 is applied.

In this embodiment, besides the decoded low resolution depth image, the up-sampling and reconstruction filter 217 uses edge information (generally—depth discontinuities), which is extracted 216 from the decoded texture image 203, and the decoded low resolution depth image 204. The details on the process of extracting edge information 216 are described below.

The reconstructed depth images 205 and texture images 203 can then be used for virtual image synthesis 113, as known in the art.

### Embodiment 2

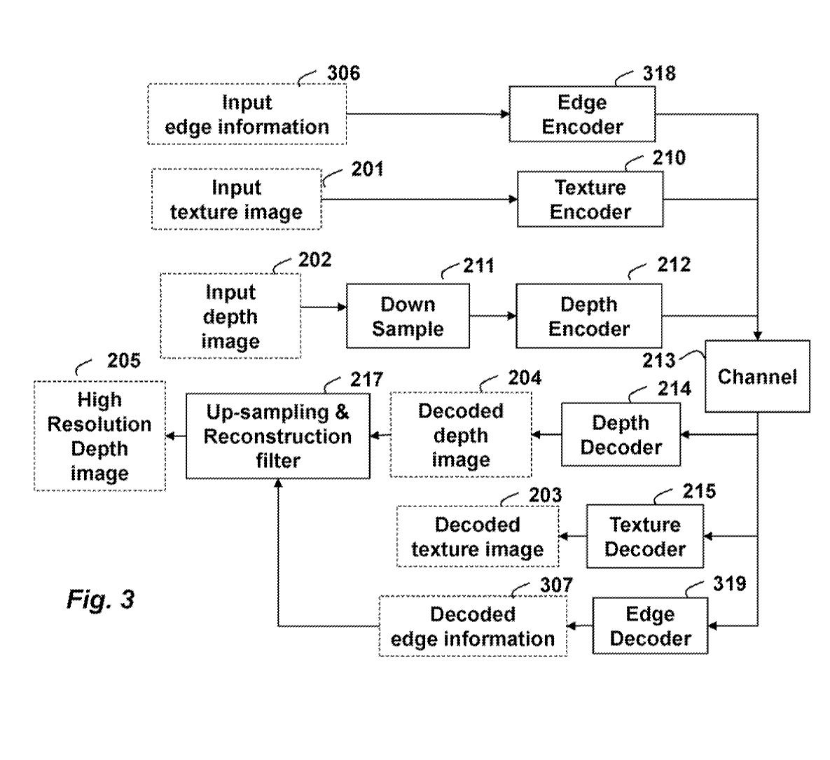

FIG. 3 shows another embodiment. The edge information is known at the encoder, and transmitted to the decoder explicitly. The edge information 306 for the input depth image 202 can be explicitly encoded 318, transmitted through the channel 213 and decoded 319 to produce decoded edge information 307. The edge information can be used by the up-sampling and reconstruction filter 217 to separate the foreground and background region, when filtering the decoded depth image.

In both embodiment 1 and 2, the reconstruction process filters after the decoding.

### Embodiment 3

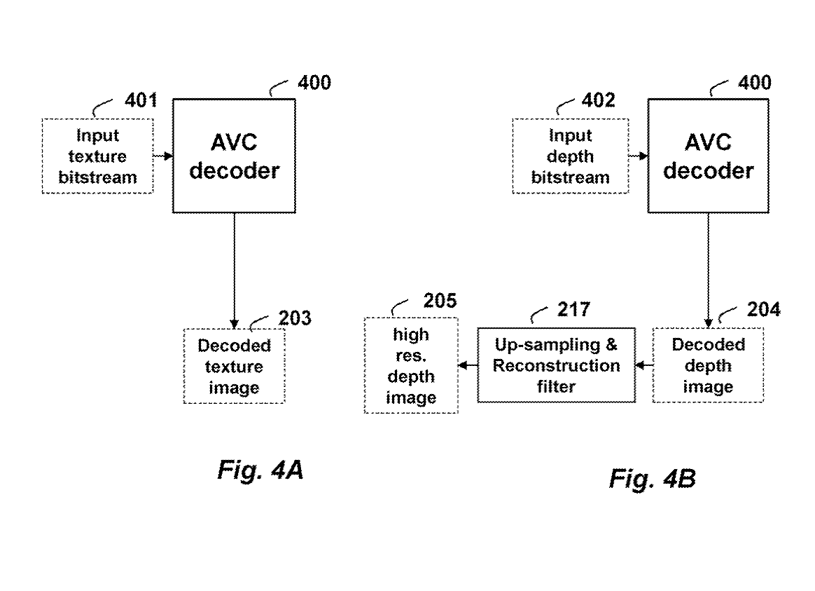

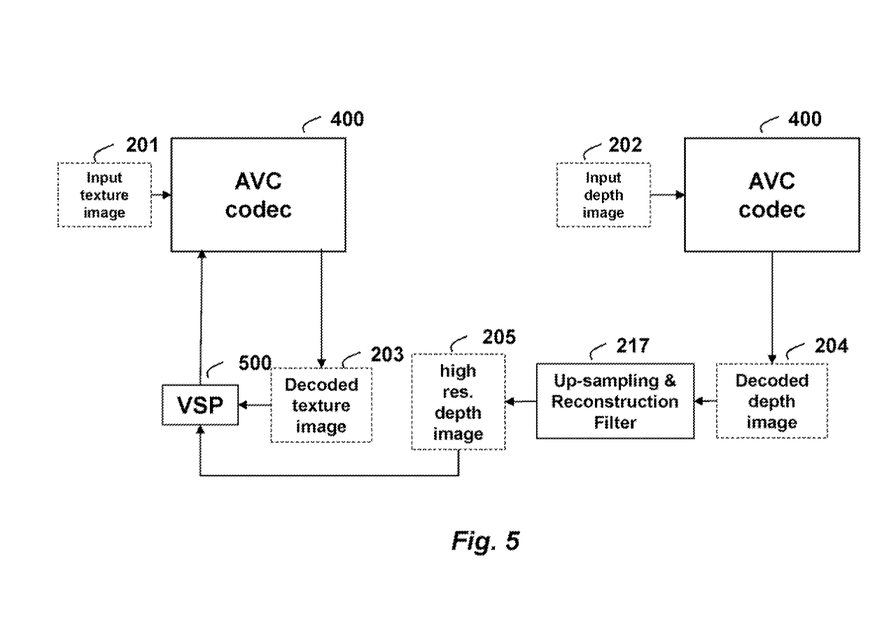

FIG. 4A shows an AVC decoder 400 for generating the decoded texture image 203 from the input texture bitstream 401.

FIG. 4B shows an AVC decoder 400 for generating the decoded depth image 204 from the input depth bitstream 402. The depth decoded depth image can subsequently be used to generate the high resolution depth image 205 with the up-sampling and reconstruction filter 217.

As shown in FIG. 4B, the reconstruction filter's output is no longer used by the encoder. That is the reconstructed high resolution depth image is outside the prediction loop.

A modified H.264/AVC codec includes an encoder and a decoder for multi-view texture and the other for multi-view depth. The depth encoder and decoder use a depth up-sampling reconstruction filter according to embodiments of our invention and described herein.

Input to the encoder includes the multi-view texture input video and the corresponding sequence of multi-view depth images. Output includes encoded bitstreams. For each frame of the input video of a selected view, there is a corresponding depth image.

Input to the decoder includes the multi-view texture bitstream and the corresponding multi-view depth bitstreams. Output includes decoded multi-view texture in full resolution and depth image in low resolution, as well as the reconstructed multi-view depth in high resolution. For each frame of the decoded video of a selected view, there is a corresponding depth image.

The current texture image of a basis view (or equivalently, the current low resolution depth image of a basis view), which is the first view to be encoded, is predicted either by motion estimation (ME) followed by motion compensation prediction (MCP), or by intra-prediction according to a selector. A difference between the current texture (or depth image) and the predicted texture (or depth image) is transformed, quantized, and entropy encoded to produce a bitstream. For the case of depth image, the input assumed here is already in low resolution. Otherwise, a pre-processing block for depth down-sampling is necessary.

The output of the quantizer is inverse quantized and inverse transformed. The inverse transform is followed by a deblocking filter producing the reconstructed texture (or depth image) in low resolution, which is stored in a frame buffer structure, to be used by subsequent frames of the input texture (or depth images) video as a reference image.

For virtual view synthesis, the full resolution texture and depth images are necessary to perform the warping operation of texture from the base view to the target view. The up-sampling reconstruction filter produces the reconstructed depth image in high resolution, and can be realized outside the decoding loop.

For the coding of the subsequent views, a similar process is realized, with the fact that texture from the base view (or any other already encoded view), can be added to the frame buffer structure, to perform interview prediction. If a side view is used as reference, the motion vectors acts as a disparity vector between views, and this disparity compensated frame can be selected as a prediction for encoding the auxiliary view.

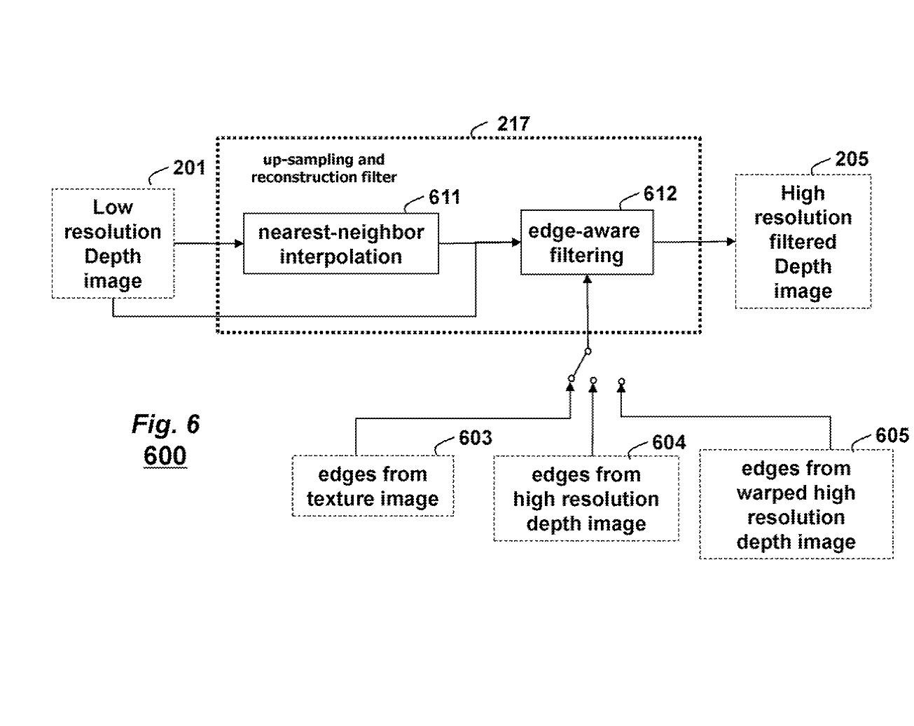

As shown in FIG. 5 for another embodiment, the reconstruction is reused by the encoder, that is, the reconstruction will be within the prediction loop of an encoder/decoder.

In the coding depicted in FIG. 5, information from the depth images is used with the corresponding decoded texture images to create virtual views at position of other views that still need to be coded. This synthesized view can be added to the frame buffer and used for prediction, and it is also known as View Synthesis Prediction (VSP) 500.

The high resolution texture image of an auxiliary view can be predicted either by MC, by intra-prediction, or by a warped frame using VSP, according to a selector. To implement the view synthesis prediction, the full resolution depth image is used, and the up-sampling and reconstruction filter 227 is placed in-loop.

FIGS. 4A-4B and FIG. 5 show encoders. It is understood that a decoder is embedded within an encoder, with the exception of the entropy decoder, which is typical of any prediction-based video standards such as MPEG-2 and H.264/AVC. This guarantees that identical reference frames are used by both the encoder and the decoder for predicting the current image. The inverse quantizer, inverse transform and the prediction structure is the same in the encoder and the decoder. In addition, the decoder has an entropy decoder block to decode the received bitstream.

### Embodiment 4

Assuming the in-loop structure described above, in this embodiment, the edge information of the high resolution depth images from a side view, which is already encoded, is warped and used by the up-sampling and reconstruction filter.

With this embodiment, no explicit transmission of edge information for the current view or edge detection is necessary. The edge information from the side view can be warped by using DIBR techniques.

In an alternative implementation, the depth image of a side view can be warped to the target position using DIBR techniques and then the edge will be detected from the warped depth image. The edge information obtained in the above ways will then be utilized in the depth up-sampling and reconstruction.

Down/Up Sampling

Above, we described embodiments that use depth up-sampling and reconstruction filtering based on edge information.

Now, we describe known techniques that can be used for depth down-sampling and up-sampling according to embodiments of the invention.

For down-sampling a 2D image, a representative depth among the pixel depths of pixels in a window are selected. We select a median depth

img_{down}(x,y)=median[img((x−1)·d+1:x·d, (y−1)·d+1:y·d)],

where d represents a down sampling factor, and
img((x−1)·d+1:x·d, (y−1)·d+1:y·d) denotes a 2D array of the pixel depths in the window.

For up-sampling a 2D image, pixels for the dropped positions will be interpolated. A straight-forward technique for pixel interpolation is simply repeating the nearest neighboring pixel. However, other techniques may also be used, such as linear or bicubic interpolation. Notice that such techniques can introduce artifacts in the reconstructed image.

Edge-Aware Filtering

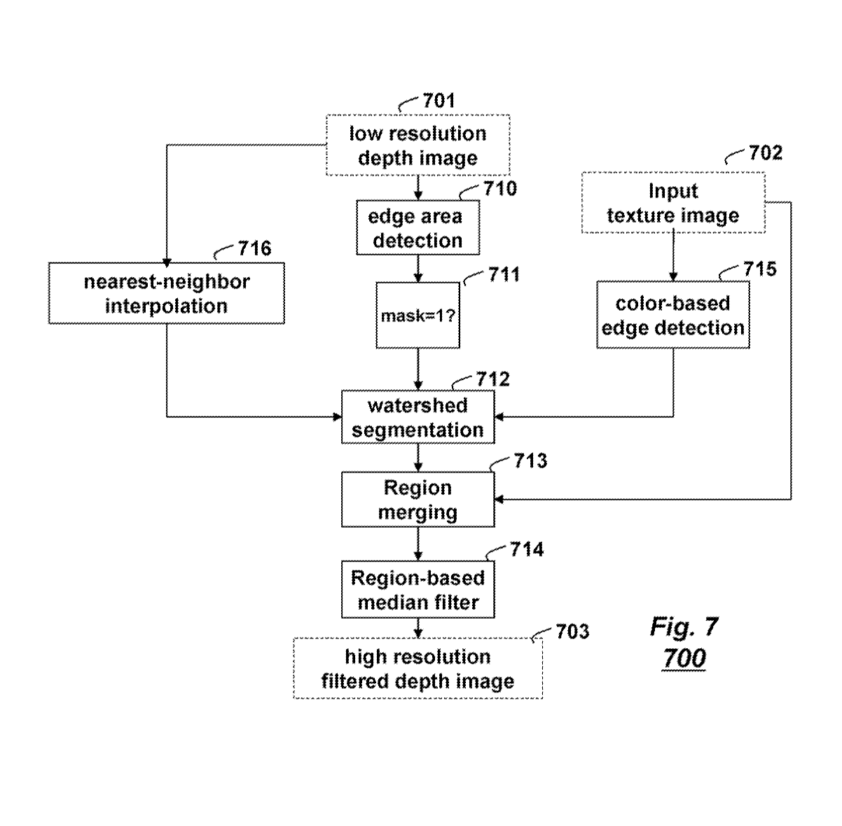

FIG. 6 shows a method of edge-aware depth up-sampling and reconstruction, as described in this invention, in combination with prior-art edge detection. The depth up-sampling 600 includes the following steps for the up-sampling and reconstruction filter 217: image up-scaling with nearest-neighbor interpolation 611 and edge-aware filtering 612, where the edge information can be obtained from the low resolution depth image 202, or from the high resolution texture 603, or can be explicitly sent to the decoder 604 or obtained by warping the depth image of neighboring views 605.

Edge-aware filtering assists the up-sampling and reconstruction of depths at a higher resolution, which can be used in the four example embodiments described above.

Our filtering selects a single representative depth within a sliding window to recover missing or distorted depths, considering the edge information provided either indirectly from the correspondent texture, or from a warped view, or even explicitly sent by the encoder.

FIG. 7 shows our reconstruction filter 700, which uses edge information, along with the blocks that show how to obtain the edge information from the high resolution texture 702. The decoded low resolution depth image 701 is used to generate a mask 711 with edge detection 710. The mask indicates the areas of the image to be filtered.

The low resolution depth image is interpolated with nearest neighboring values 716, and the image is processed in overlapping blocks of size 6×6, where only the middle 2×2 block values is be modified.

For each 6×6 block, if there is one pixel marked for post-filtering 711, than edge-aware region-based median filtering is performed, otherwise the block is copied to the output. The filtering procedure includes color-based edge magnitude estimation 715 using texture 702, followed by a watershed segmentation procedure 712.

The regions generated by the segmentation procedure are merged 713 into two disjoint regions. For each region, the median value of the corresponding region substitutes the depth values of the region, generating a constant-valued region, and filtering the center values of the region-based median filter 714, resulting in the high resolution filtered depth image 703, whose depths arc in accordance with the obtained edge. Next, we describe important blocks in the process.

Detection of Edge Discontinuity

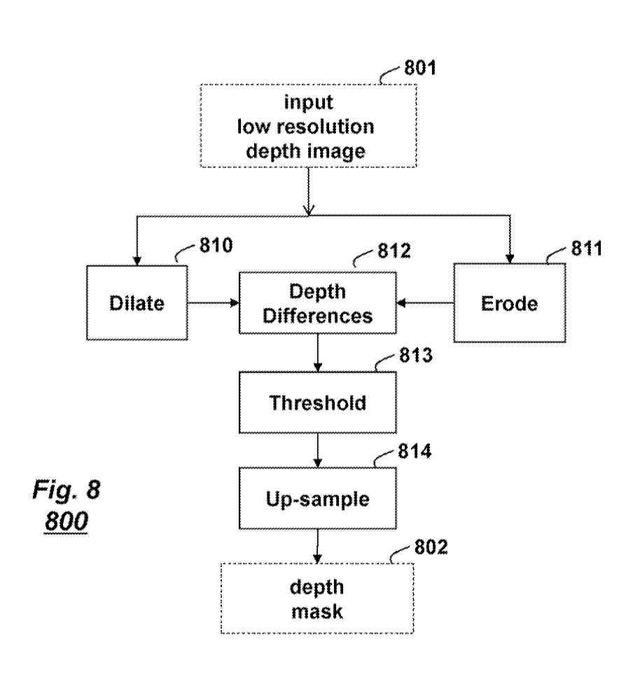

FIG. 8 shows a procedure for detecting an area in the depth image where there are edges. By performing dilation 810 and erosion 811 in the down-sampled depth-image 801, structures in the scene enlarge and shrink, respectively.

Depth differences 812 between two intermediate images produced by the dilation and erosion have high values near edges. Therefore, a threshold 813 can determine the areas of the image where the edge is located. The mask is then up-sampled 814 to produce a depth mask 802, which indicates whether a block of the interpolated decoded high resolution depth image should be post-processed, or not.

Dilation and Erosion

Morphological dilation and erosion are well known terms in the art of image processing. The state of any pixel in the output image is determined by applying rules to the corresponding pixel, and its neighbors in the input image.

For the dilation rule, the depth of the output pixel is the maximum depth of all the pixels in the neighborhood of the input pixel. Dilation generally increases the sizes of objects, filling in holes and broken areas, and connecting areas that are separated by small spaces. In gray-scale images, dilation increases the brightness of objects by taking the neighborhood maximum. With binary images, dilation connects areas that are separated by distance smaller than a structuring element, and adds pixels to the perimeter of each image object.

Erosion

For the erosion rule, the depth of the output pixel is the minimum depth of all the pixels in the neighborhood. Erosion generally decreases the sizes of objects and removes small anomalies by subtracting objects with a radius smaller than the structuring element. In grays-scale images, erosion reduces the brightness, and therefore the size, of bright objects on a dark background by taking the neighborhood minimum.

Color-Edge Magnitude

Edge information extracted from color images can be more reliable. We extract the edge magnitude from each color channel by first applying a smoothing Gaussian filter, and then a differential filter to the smoothed input. The maximum magnitude of the three channels is retained. The resulting edge magnitude is used to determine the boundaries of objects, using watershed segmentation.

Watershed Segmentation

The watershed segmentation procedure considers the edge magnitude input image as a terrain, and uses a geophysical model of rain falling in the terrain to segment the image. The concept of the watershed transform is based on the idea that a raindrop falling on a surface follows the path of steepest descent to a minimum. A catchment basin is the set of points on the surface that lead to the same minimum, and borders between catchment basins are the divisions between regions, also known as watershed lines.

A know issue with watershed transform is over-segmentation. Therefore, the watershed transform is usually followed by a clustering or merging operation. In our case, the transform is applied in a block-by-block basis, where blocks of size 6×6 that contain an edge pixel are selected for segmentation.

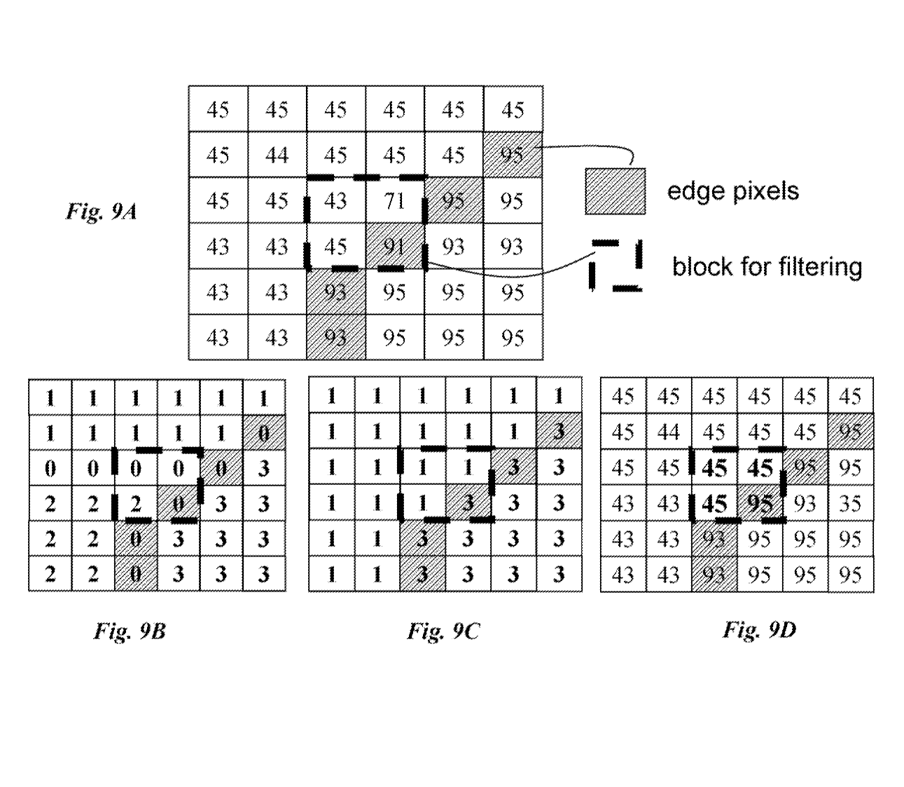

FIG. 9A shows a block of the depth image, where the integers correspond to the depths at selected pixels. The marked pixels indicate an edge that is crossing the block.

FIG. 9B shows the block segmented using the watershed procedure. Each region is identified by its respective number, shown in place of the depths, and the procedure partitions the block into three regions. The pixels with the zero labels are the watershed lines, indicating the boundaries of each region.

Region Clustering

Because the watershed transform usually generate more regions than necessary, we apply a clustering procedure that is based on the average color information in each region. For each region, the average value of all the color pixels present in the region is determined. For all neighboring regions, we determine the average color value of the union of these two regions using a weighted sum of their respective color values, and their areas as weighting factors.

Then, the cost of uniting two regions is given by the difference between the actual color and the color resultant from the union, weighted also by the area of each region.

For example, in FIG. 9B, the cost of clustering region l and 2 is compared with the cost of joining regions of pixels 1 and 3 and regions of pixels 2 and 3. Neighboring regions with a minimum cost are merged. The clustering procedure is performed iteratively until only two regions are left unmerged. By the end of the procedure, pixels are marked either belonging to region A or region B, or the boundary between these two regions. Then, the depths are averaged for each region, to identify the foreground and the background region. The pixels in the transition area are assimilated in the foreground region.

FIG. 9C shows the final result of clustering regions identified by the watershed transformation shown in FIG. 9B. Regions of pixels 1 and 3 remain after the merging procedure, and these two regions are used for a median calculation.

Region-Based Median Filtering

In FIG. 9A, the 6×6 block is identified by the edge detection procedure using the decoded low resolution depth image, and the 2×2 central values are modified with values present on the neighborhood.

The watershed segmentation (FIG. 9B) and clustering procedure (FIG. 9C) partition the block into two regions, as showed in FIG. 9C, for the numbered pixels 1 and 3.

For each region, the median value of the depth values is determined. The pixels in the central 2×2 block have the corresponding median value of the region to which the pixels belongs.

FIG. 9D shows the modified depths of the central block in bold numbers. Because three of four pixels belong to the same region, their values are the same, while the remaining value for the other region has a different median value. Then, the sliding window moves two pixels to the right, and filters the next 2×2 block, again with an overlapping 6×6 neighborhood, when the edge mask indicated to filter the block. The filtering can be performed in a raster-scan order. In this way, the edges are well preserved, and outlier values are also removed by the filtering procedure.

### Effect of the Invention

Our depth up-sampling and reconstruction filter includes an edge-aware region-based median filter. The filter is non-linear, and takes into consideration characteristics of depth images to reduce coding errors, as well as edge information to recover the depth information that is lost in the down-sampling and coding procedure. By using the edge information, the up-sampled reconstructed depth image has a higher quality, and generates synthetic views with higher quality.

When edge-aware depth up-sampling is used as an in-loop filter and combined with view synthesis prediction, the coding efficiency is improved because a higher quality synthetic reference can be generated using our depth up-sampling technique.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for generating a high resolution depth image from a low resolution depth image, comprising the steps of:
up-sampling the low resolution depth image based on neighboring depth values to produce an up-sampled depth image;
selecting particular pixels within a window from the up-sampled depth image according to a relative position to a depth discontinuity; and
filtering only the particular pixels to assign a depth to the particular pixels to generate the high resolution depth image, wherein the steps are performed in a decoder.

2. The method of claim 1, wherein the steps are also performed in an encoder.

3. The method of claim 1, wherein the depth discontinuity is determined from a correspondent texture image.

4. The method of claim 1, wherein the depth discontinuity is determined by an encoder.

5. The method of claim 1, wherein the depth discontinuity is determined from the low resolution depth image.

6. The method of claim 1, wherein the depth discontinuity is determined from a high resolution side view depth image, after warping.

7. The method of claim 1, wherein the depth image is acquired of a 3D scene.

8. The method of claim 1, further comprising:
synthesizing a texture image at a different viewpoint based on the high resolution depth image and correspondent texture image to produce a synthesized texture image; and
predicting the texture image at the different viewpoint based on the synthesized texture image.

9. The method of claim 1, wherein the low resolution depth image is down-sampled before encoding.

10. The method of claim 1, applying a reconstruction filter to the up-sampled depth image.

11. The method of claim 1, wherein the steps are performed outside a prediction loop.

12. The method of claim 1, wherein the depth discontinuity is received by a decoder as part of a bitstream.

13. The method of claim 1, wherein the steps are performed within a prediction loop.

14. The method of claim 6, wherein the warping uses depth-image based rendering.

15. The method claim 10, wherein the reconstruction filter uses edge-aware region-based median filtering on regions.

16. The method of claim 15, wherein the filtering includes color-based edge magnitude estimation using texture, followed by a watershed segmentation procedure.

17. The method of claim 1, wherein the depth discontinuity uses dilation and erosion to generate two intermediate images, and further comprising:
determining depth difference between the two intermediate images; and
thresholding the depth differences to produce a depth mask.

18. The method of 16, further comprising:
clustering the regions based on average color information in each region.
